(19) United States
(12) Patent Application Publication
(10) Pub. No.: US 2009/0019798 A1
(43) Pub. Date: Jan. 22, 2009

(54) CONSTRUCTION ELEMENT FOR VITRIFYING A BUILDING

(75) Inventors: Helmut Teschner, Landsberg (DE); Roland Burkhardt Roth, Kreuzlingen (CH)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/721,633

(22) PCT Filed: Oct. 24, 2005
(86) PCT No.: PCT/DE2005/001905

§ 371 Date: Sep. 17, 2008

(30) Foreign Application Priority Data
Dec. 13, 2004 (DE) 10 2004 059 959.9

(51) Int. Cl. E06B 3/00; E04F 13/14; E06B 3/54

(52) U.S. Cl. 52/204.55

(57) ABSTRACT

A component (10) for glazing of a building which has at least one glass pane (12) and a shatter-proofing element (30) which is connected to the glass pane. In the peripheral edge region (14), the shatter-proofing element has at least one holding device (18) for attachment to the building. Furthermore, in this approach, it is advantageous that, on the one hand, a comparatively light glass pane can be used which does not release dangerous fragments into the building or into the vicinity of the building by virtue of the shatter-proofing element when a pane breaks.

### BACKGROUND OF THE INVENTION

1. Field of the Invention

This invention relates to a component for glazing of a building which has at least one glass pane and a shatter-proofing element which is connected to the glass pane.

2. Description of Related Art

German Utility Model DE 201 09 00 U1 discloses such a component which has a glass plate of single-pane safety glass to which a shatter-proofing film is applied. The shatter-proofing film is cemented or laminated onto one side of the glass plate. In an alternative embodiment, the glass plate is composed of two panes which are joined to form a two-pane laminated safety glass via the known shatter-proofing film.

European Patent Application EP 1 026 338 A2 discloses curved glazing for overhead glazing, decoration, noise abatement or the like, consisting of a mechanically bent pane of flat glass. In order to prevent large glass fragments from falling down when a pane breaks, a shatter-proofing film can also be used here which holds the glass fragments together upon breakage similarly to a laminated safety glass. Side holding elements which encompass the glass pane are suggested for attaching the glazing elements.

German Patent DE 102 06 717 A1 and corresponding U.S. Pat. No. 6,908,174 disclose a glass cover with a shatter-proofing film for closing the opening of a vehicle roof which is provided with a transparent pane of safety glass, on the bottom of the pane or on the bottom of a solar cell combination which is located on the bottom of the pane, a shatter-proofing film being attached. To attach the glass cover to the vehicle, there is an inner cover sheet on its bottom which is embedded in the peripheral foam which surrounds the glass cover and which is used as a support arrangement for the pane. A folded-over region of the shatter-proofing film is connected by means of a screw connection or the like to the inner cover sheet, and in this way, in turn, to the body. Thus, for a broken pane, the shatter-proofing film with the adhering pane fragments is no longer flexurally stiff, but can continue to be held in place by the holding element. This is intended to prevent the broken pane together with the shatter-proofing film from becoming detached from the frame.

### SUMMARY OF THE INVENTION

The object of this invention is to devise a component for glazing of a building in which a glass construction with a shatter-proofing element, on the one hand, can be implemented in a lightweight construction and which, on the other hand, is still securely held on the building when a pane of glass breaks.

This object is achieved in accordance with the invention by a component and an application of such a component in which the shatter-proofing element has a least one holding device in the peripheral edge region which is used for attachment to the building.

In this approach, it is advantageous that, on the one hand, a comparatively light glass pane can be used which does not release dangerous fragments into the building or into the vicinity of the building by virtue of the shatter-proofing element when a pane breaks. The use of laminated safety glass (VSG) is thus no longer critically necessary; this leads to a considerable weight reduction. This advantage is combined with the further advantage that because the shatter-proofing element is attached to the building in the peripheral edge region via a holding device, even a broken pane which remains hanging on the shatter-proofing film together with it cannot fall completely into the building or away from the building into the vicinity. In this way, it is possible to prevent articles and fragments from being able to penetrate from the outside through the broken pane into the interior of the building and the interior from becoming freely accessible when the pane is destroyed in the case of a burglary.

While holding devices (for example, holes or loops) can be directly integrated into the shatter-proofing element, the shatter-proofing element being attached to the building with the holding devices, in preferred embodiments of the invention, the holding device is a separate additional holding element which connects the shatter-proofing element to the building.

The shatter-proofing element in other preferred embodiments of the invention is connected to the glass pane by means of an adhesive film such as, for example, a hot-setting adhesive film. Preferably, the shatter-proofing element is laminated onto the glass pane here.

In especially preferred embodiments of the invention, at least in partial regions of the shatter-proofing element, between the latter and the glass pane, a solar cell combination is attached, with which the component is also able to contribute to power supply.

The shatter-proofing element can also be connected to the glass pane over the entire surface, or in embodiments of the component with an integrated solar cell combination, the shatter-proofing element in regions with solar cells is connected to the solar cells and in regions which are not covered by solar cells it is, in turn, directly connected to the glass pane.

In other embodiments of the invention, the holding element is connected not only to the shatter-proofing element itself, but also directly to the glass pane. The holding element can be cemented to the glass pane and the shatter-proofing element. In alternative embodiments of the invention, the holding element is connected via peripheral edge foaming or back-foaming to the glass pane, and the shatter-proofing element is foamed, in turn, into the peripheral edge foaming or back foaming, and thus, likewise, attached to the holding element. In order to further improve the holding forces of the shatter-proofing element on the holding element, in versions of cementing or foaming, the surface of the shatter-proofing element can be provided with means to increase the adhesion between the shatter-proofing element and the cement or peripheral edge foaming. Examples of this include surface roughening of the shatter-proofing element or alternative application of a raised structure. In other preferred embodiments of the invention, the holding element is especially screwed to the shatter-proofing element and can be additionally screwed likewise to the glass pane. In other embodiments of the invention, the shatter-proofing element is clamped in the holding element, and in especially preferred embodiments, the holding element is used at the same time to attach the entire component to the building.

The shatter-proofing element, itself, can be a composite material or a shatter-proofing film, and in especially preferred embodiments, it is a shatter-proofing film composite. In these embodiments, the use of ethyl-vinyl acetate films (EVA) is especially preferred. In another preferred configuration of the invention, the glass pane is single-pane safety glass which yields a weight reduction in particular. A component in accordance with the invention can be used, on the one hand, to glaze the facade of a building, and the corresponding components can be attached in transparent window regions and also on the non-transparent parts of the facade. Alternatively, a component in accordance with the invention can also be used for overhead lining in order to obtained roof-like glazing.

The invention is explained in detail below with reference to the accompanying drawings by way of example.

### BRIEF DESCRIPTION OF THE INVENTION

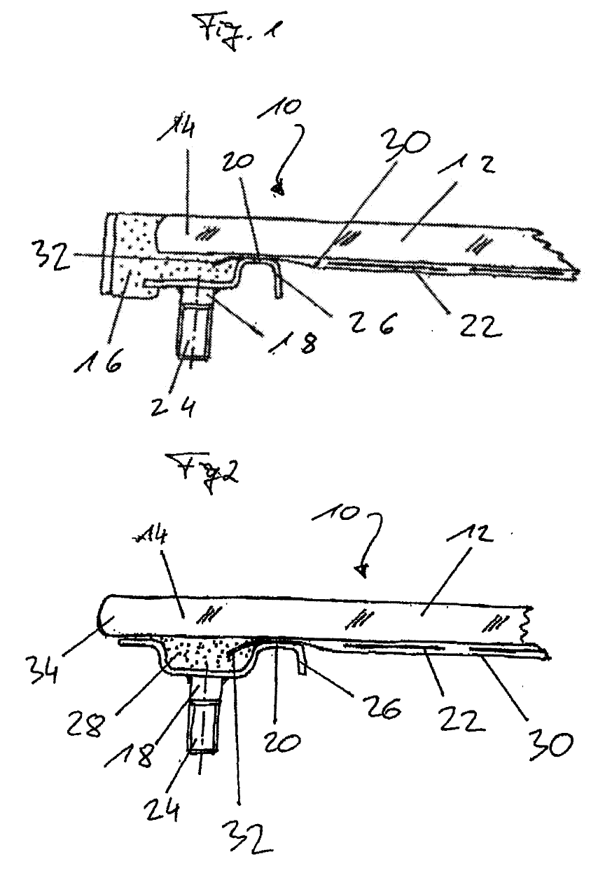

FIG. 1 shows a cross section of the edge region of a component in accordance with the invention according to a first embodiment; and

FIG. 2 is a view like that of FIG. 1 but showing a second embodiment of the invention.

### DETAILED DESCRIPTION OF THE INVENTION

FIG. 1 shows a component 10 in accordance with the invention which has a glass pane 12 of ESG (single-pane safety glass) which is provided in the edge region 14 with a peripheral edge foaming 16. The peripheral edge foaming 16 joins the glass pane 12 to the holding element 18 which has an extension 24 with which the component 10 for glazing a building can be attached to a facade. On the side of the component 10 facing the building, a shatter-proofing film 30 is applied to the glass pane 12, and in partial regions of the glass pane, between it and the shatter-proofing film 30, moreover, a solar cell combination 22 is attached. The shatter-proofing film 30 is cemented directly on the glass pane to the back of the solar cell combination 22 and to partial regions of the glass pane 12 which are not covered by the solar cell combination.

Cementing can be achieved by way of an adhesive film or hot-setting adhesive film (not shown) which, for example, fixes the shatter-proofing film 30 accordingly in a lamination process. Alternatively, the shatter-proofing film 30, itself, can be made as an adhesive film, by which layer build-up is simplified. The solar cell combination 22 which is thus located between the shatter-proofing film 30 and the glass pane 12 can convert the solar radiation which is incident on the component 10 into energy which can be delivered to the building via lines (not shown). The solar cell combination 22 can, itself, be cemented on the glass pane 12 independently of the shatter-proofing film 30, or it is placed on the glass pane 12 when the component 10 is installed and when the shatter-proofing film 30 together with it is laminated onto the glass pane 12.

When a glass pane 12 breaks, to prevent its detaching completely from the building to the inside or outside together with the shatter-proofing film 30, in accordance with the invention, the shatter-proofing film is attached separately and additionally to an end 32 in the edge region 14 on the holding element 18. Via this attachment, which is achieved in the illustrated embodiment of the invention by way of foaming of the shatter-proofing film 32 into the peripheral edge foaming 16 of the component 10, indirect, nonpositive connection from the end 32 via the peripheral edge foaming 16 into the holding element 18 and via its extension 24 into the building (not shown) is ensured. To optimize foaming-in of the shatter-proofing film 30, furthermore, the end 32 of the shatter-proofing film in this end region is not cemented flat onto the glass pane 12, but the shatter-proofing film, here, is folded or guided away from the glass pane into the peripheral edge foaming 16.

The holding element 18 also has a clamping finger 26 which is made such that it presses the shatter-proofing film 30 against the glass pane 12 in the clamping region 20. Thus, at this point, on the one hand, self-sealing is achieved in the foaming of the peripheral edge foam 16, which simplifies the process of production of the component 10, and on the other hand, the connection between the shatter-proofing film and holding element is strengthened by the clamping action in the clamping region 20.

One alternative embodiment of the invention is shown in FIG. 2, in which, as in FIG. 1, a cross-sectional view through the edge region 14 of the component 10 in accordance with the invention is shown. Similar to FIG. 1, here, the component 10 is provided with a shatter-proofing film 30 and also there is a solar cell combination 22 between the shatter-proofing film and the glass pane. However, in contrast to FIG. 1, in FIG. 2, the holding element 18 is not attached by means of peripheral edge foaming of an edge region 14 thereof, but the holding element and one end 32 of the shatter-proofing film 30 are connected to one another and to the glass pane 12 via cementing 28. The necessity of peripheral edge foaming is thus eliminated in this embodiment of the invention.

The cementing 28 of the glass pane 12 is performed such that an edge remains free of the cement in the edge region 14, by which an optically pleasing image of the building facade arises since it is not possible to look onto the cement 28 or peripheral foam.

What is claimed is:

1-22. (canceled)

23. Component for glazing of a building which has at least one glass pane and a shatter-proofing element which is connected to the glass pane, wherein a peripheral edge region of the shatter-proofing element has at least one holding device for attachment to the building.

24. Component as claimed in claim 23, wherein the holding device comprises a holding element.

25. Component as claimed in claim 23, wherein the shatter-proofing element is connected to the glass pane by means of an adhesive film.

26. Component as claimed in claim 23, wherein a solar cell combination is located between the shatter-proofing element and the glass pane in partial regions of the shatter-proofing element.

27. Component as claimed in claim 26, wherein the shatter-proofing element is connected over the entire surface of a glass pane of the solar cell combination.

28. Component as claimed in claim 23, wherein the shatter-proofing element is connected over the entire surface of the glass pane.

29. Component as claimed in claim 24, wherein the holding element is also connected to the glass pane.

30. Component as claimed in claim 29, wherein the holding element is cemented to the glass pane and the shatter-proofing element.

31. Component as claimed in claim 29, wherein the holding element is connected to the glass pane via a peripheral edge foaming or back-foaming and the shatter-proofing element is foamed into the peripheral edge foam or back-foam.

32. Component as claimed in claim 31, wherein the surface of the shatter-proofing element is provided with means for increasing adhesion between the shatter-proofing element and the peripheral edge foaming or back-foaming.

33. Component as claimed in claim 32, wherein the means for increasing adhesion are holes made in the shatter-proofing element for passage of the peripheral edge foaming or back foaming.

34. Component as claimed in claim 30, wherein the surface of the shatter-proofing element is provided with means for increasing adhesion between the shatter-proofing element and the cement.

35. Component as claimed in claim 33, wherein the means for increasing adhesion are holes made in the shatter-proofing element for passage of the cement.

36. Component as claimed in claim 34, wherein the means for increasing adhesion is a surface roughening of the shatter-proofing element.

37. Component as claimed in claim 34, wherein the means for increasing adhesion are raised structures applied to the surface of the shatter-proofing element.

38. Component as claimed in claim 29, wherein the holding element is attached by screws to the glass pane and the shatter-proofing element.

39. Component as claimed in claim 24, wherein the shatter-proofing element is clamped in the holding element.

40. Component as claimed in claim 23, wherein the holding device is adapted for attaching the component to the building.

41. Component as claimed in claim 23, wherein the shatter-proofing element is a composite material.

42. Component as claimed in claim 23, wherein the shatter-proofing element comprises at least one shatter-proofing film.

43. Component as claimed in claim 42, wherein the shatter-proofing element comprises at least one ethyl-vinyl acetate film (EVA).

44. Component as claimed in claim 23, wherein the glass pane is a single-pane safety glass (ESG).

45. Component as claimed in claim 23, wherein the component is a facade lining element.

46. Component as claimed in claim 23, wherein the component is an overhead glazing element.
